(19) United States
(12) Patent Application Publication
(10) Pub. No.: US 2006/0086917 A1
(43) Pub. Date: Apr. 27, 2006

(54) Tap and faucet security

(76) Inventor: Willem Viljoen, Pretoria (ZA)

Correspondence Address: Hahn and Moodley LLP, Suite180, 800W EI Camino Real, Mountain View, CA, 94040, US

(21) Appl. No.: 11/200,605

(22) Filed: Aug. 10, 2005

(30) Foreign Application Priority Data
Aug. 10, 2004 (ZA) ZA2004/6315

(51) Int. Cl. F16K 35/00

(52) U.S. Cl. 251/96

(57) ABSTRACT

A device for controlling the use of a tap, for the safety of children control of adults, which includes a sleeve adapted to fit over a spindle of a tap after removal of the tap handle from the spindle, the sleeve having a fastening means to fasten it to the spindle, the sleeve having a key formation presented at its distal end and further includes a co-acting key formation adapted to be fitted to a grip.

This application claims priority to South African Patent Application Number ZA2004/6315, filed on Aug. 10, 2004, which is hereby incorporated herein by reference.

### FIELD OF INVENTION

This invention lies in the field of child safety appliances or devices or measures or tamper proof devices. The invention may have particular application in a domestic context, but is not limited to that. The invention can also be used for restricting access to or use of appliances or devices in general, i.e. making devices tamper proof, not only in regard to children, but also adults. Taps, faucets, valves and cocks are of particular application.

### BACKGROUND

Safety of children is enjoying increasing attention and requires a special approach as compared with domestic safety measures in general. Children are especially vulnerable because of their inexperience and naivety, so that appliances and devices that are quite safe for adults represent a danger to children. In practice a moment can always arise when a child is unattended and can do something that presents a danger of injury or damage to property.

One area where this can arise but where very little has been done to provide for safety of children, is in the taps and faucets of a building that provide access to piped water, both hot and cold, under pressure, e.g. from a municipal or other supply. Children keep moving around in a house and often play in bathrooms. A hot tap opened by a child can represent a danger of being very seriously scalded, if the water is very hot. Domestic hot water supply can be set to be very hot, if the user so chooses. A cold water tap opened and left open, for example by a child who gets a fright or does not realise how to shut a tap, can cause flooding and concomitant extensive damage. Flooding can also represent a danger of drowning, considering that recorded cases have shown that drowning can occur in particular circumstances when only a few centimetres of water are present. A child may get into a bath and turn a tap on, slip and fall knocked unconscious into the water in the bath; a young child may be helped into a bath by older children and unable to get out when the older children thoughtlessly leave it. Fears of these possibilities can plague parents, even without them having ever happened.

Circumstances also arise where it is desirable to make a tap tamper proof, for example where a tap is used and abused by passers by, sometimes left running or forced etc.

The present invention addresses these dangers, problems and concerns and focuses on taps having a handle on a spindle that may be turned up to several turns, rather than a lever that is raised or lowered or moved a limited amount from side to side.

### THE INVENTION

A device for controlling operation of a tap in accordance with this invention includes a sleeve adapted to fit over a spindle of a tap after removal of the tap handle from the spindle, the sleeve having a fastening means to fasten it to the spindle, the sleeve having a key formation presented at its distal end and a co-acting key formation adapted to be fitted to a grip.

The grip may be a separate component or the tap handle itself may be used as the grip, the grip then being subject to security, so that the tap cannot be operated without it.

An alternative arrangement is for the key formation of the grip to be spring loaded out of engagement with the sleeve key formation of the sleeve, so that normally it will not operate the tap, but if the grip is simultaneously pushed so that the key formation of the grip engages the key formation of the sleeve, then turning the grip will operate the tap.

It is an important preferred feature that the distal end of the sleeve presents no sharp edges and is carefully rounded and smoothed so that a person who falls or bangs against it accidentally, will not be injured.

The co-acting key formation may be fitted to the spindle in a spring loaded manner, adapted to be displaced against the spring action so that the co-acting key formation engages the key formation on the sleeve, to enable actuating the tap.

In accordance with a preferred embodiment of the invention a cover or case is provided, adapted to conceal the sleeve, except for its distal end that presents the key formation. This can be provided for aesthetic purposes, as well.

The method of use of the invention is to remove the handle of a tap from the tap spindle, fit the sleeve over the spindle and fasten to sleeve to the spindle, fit the co-acting key formation to the grip or tap handle and store the tap handle in a secure place. The secure place will be selected to be inaccessible to a child, e.g. a high cupboard, locked cupboard or others. For use by adults the handle with fitted key formation is applied to the key formation presented at the distal end of the sleeve and the tap is operated. The handle must be replaced after use in a safe place.

In accordance with a preferred embodiment of the invention there is provided a means of holding or storing the handle with fitted key formation and adapted for mounting in a safe and convenient location, e.g. high on a wall. The means may be an article ranging from a mere hook or dish to an enclosure, which one could have the option of locking.

The key formation presented at the distal end of the sleeve may be a socket-like or female formation to which a spigot-like or male formation may be engaged to provide a rotational connection, but allow easy withdrawal of one from the other. Examples are a hexagon socket and matching hexagon spigot or peg and many other mechanically equivalent formations can be adopted which have an equivalent function.

The sleeve maybe adapted to be fastened to the spindle of the tap by means of a grub screw, for example, a screw and wedge structure and other mechanically equivalent means that achieves the same purpose.

In accordance with the invention a set or kit may be provided consisting of more than one sleeve, of varying diameters, to provide for different taps or ranges of taps. A similar set or kit of key formations can be provided for different tap handles. Should any tool be required for applying the invention, this can conveniently be included in the kit or set, to be sold as a package for the convenience of the householder, for example.

Apart from the option of providing a set of sleeves, e.g. two or more, for different tap spindles, one may provide a basic sleeve and one or more supplementary sleeves, dimensioned to fit into the basic sleeve so as to allow reducing the effective inner dimension once the supplementary sleeve has been fitted into the basic sleeve, to provide the desired close fit on a smaller diameter tap spindle.

The components of the invention may be provided in a suitable polymeric material, metal or other suitable material.

### THE REPRESENTATIONS

The invention is more fully described by way of example, with reference to the drawings and photographs, in which:—

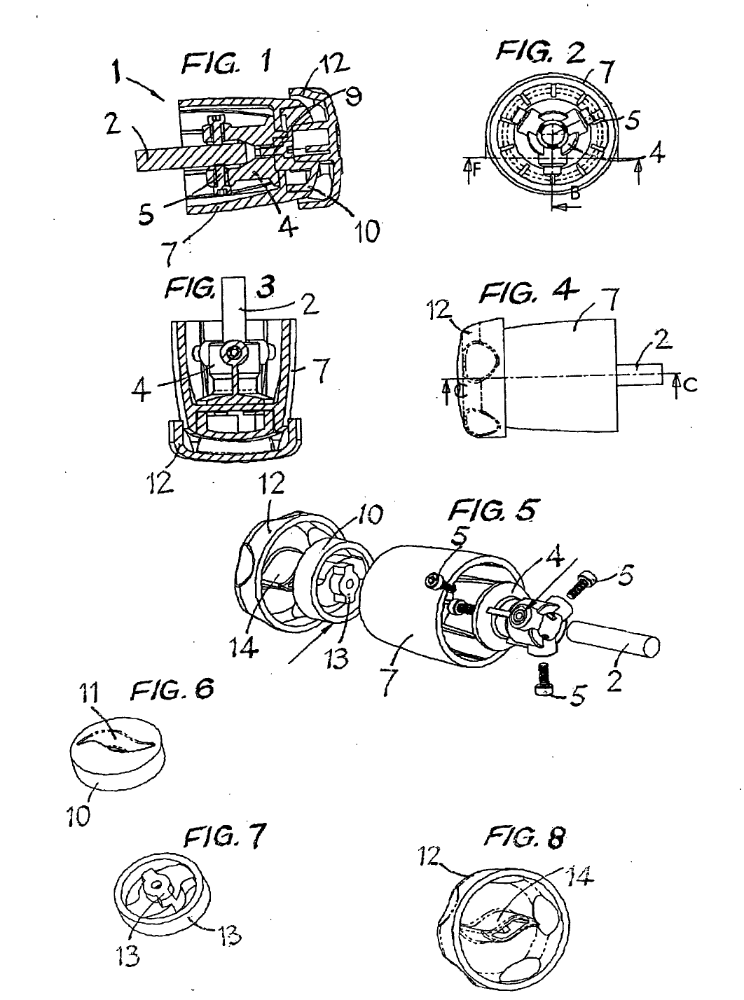

FIG. 1 is an axial cross section on section B-B shown in FIG. 9, of a tap modified in accordance with the invention,

FIG. 2 is a rear view of the device,

FIG. 3 is an axial cross section on section F-F shown in FIG. 2,

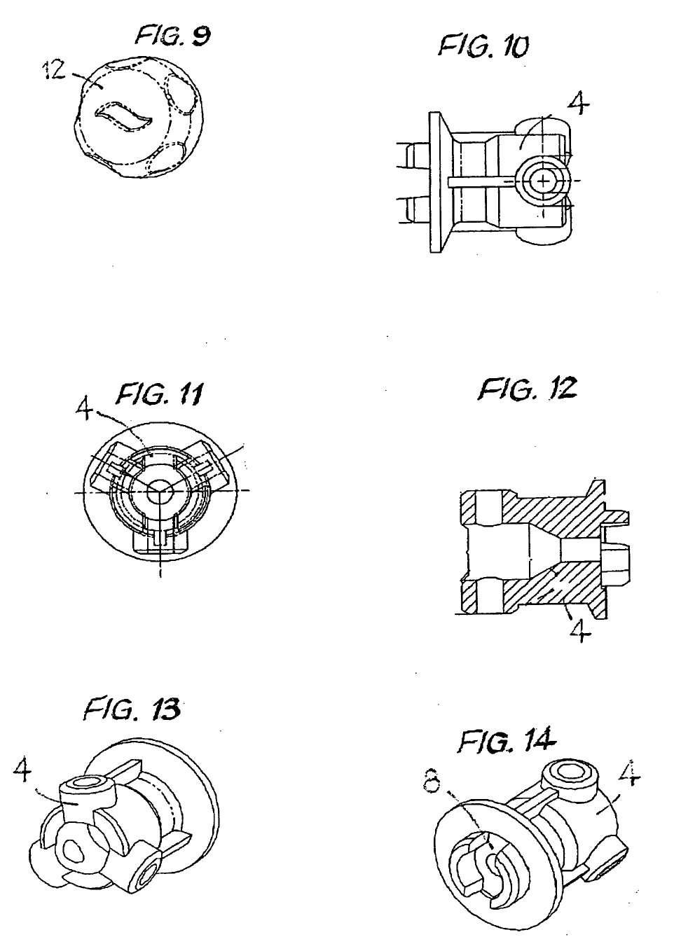

FIG. 4 is a side view of the device,

FIG. 5 is an “exploded” isometric view of the device,

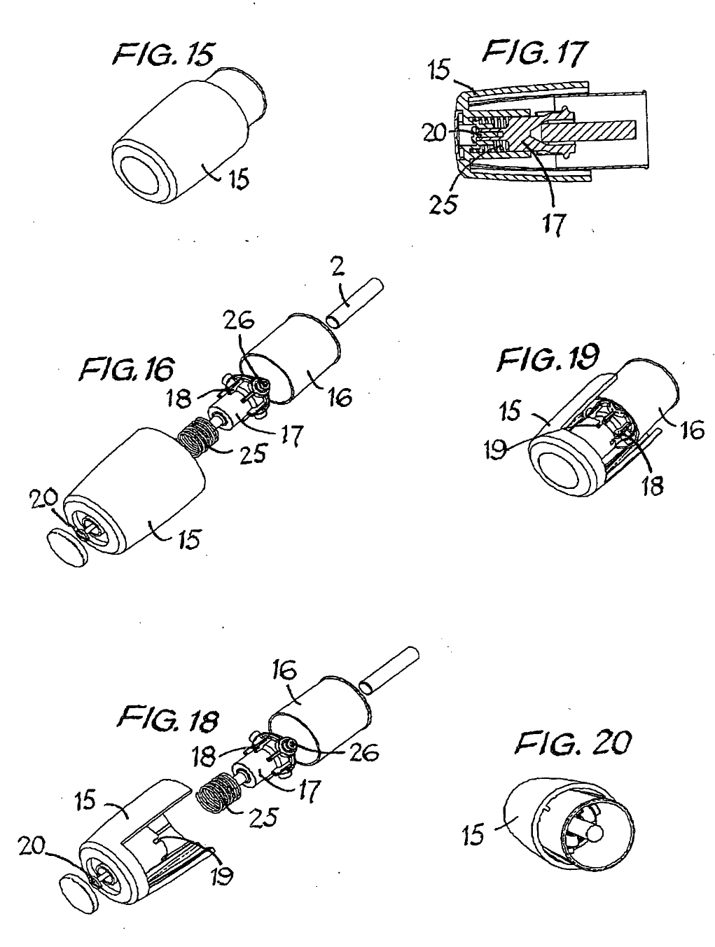

FIG. 6 is an isometric view of the outer side of the formation of the device,

FIG. 7 is an isometric view of the inner side of the formation of the device,

FIG. 8 is an isometric view of the inner side of the grip for the device,

FIG. 9 is an isometric view of the outer side of the grip for the device,

FIG. 10 is a side view of the sleeve to be fitted onto the tap spindle,

FIG. 11 is an end view of the sleeve,

FIG. 12 is an axial section on section B-B shown in FIG. 11,

FIG. 13 is an isometric view of a distal end of the sleeve,

FIG. 14 is an isometric view of a proximal end of the sleeve,

FIG. 15 is an isometric view of a device according to another embodiment of the invention,

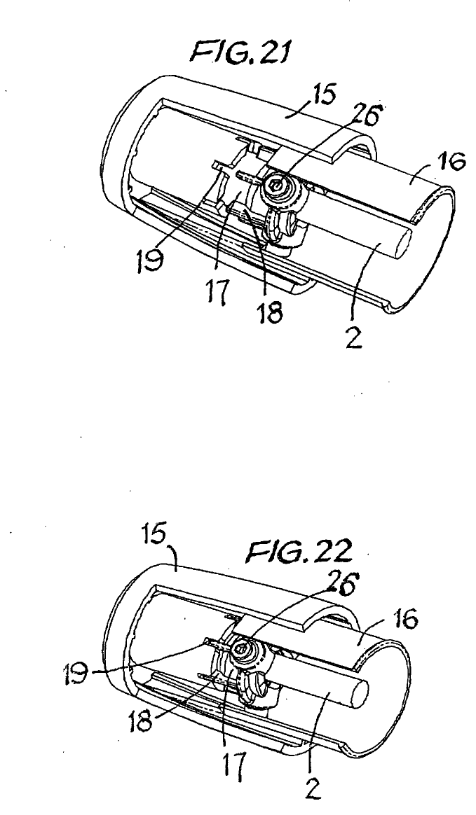

FIG. 16 is an “exploded” isometric view of the device shown in FIG. 22,

FIG. 17 is an axial cross sectional view of the device,

FIG. 18 is an “exploded” isometric view of the device with the cover partially cut away to show the inside,

FIG. 19 is a view of the device with the cover partially cut away to show inside,

FIG. 20 is an isometric view of the device,

FIG. 21 is an isometric view of the device with grip and sleeve partially cut away before depression of the grip, and

FIG. 22 is an isometric view of the device with grip and sleeve partially cut away after depression of the grip.

### THE PREFERRED EMBODIMENTS

Referring to FIGS. 1 to 14, these show the device 1 attached to the tap spindle 2. The spindle 2 of the tap has had the conventional parts of the tap removed. The sleeve 4 is fitted to the spindle and fastened by tightening screws 5. A cover 7 is placed over the sleeve, the cover conceals the sleeve, prevents access to the screws and provides an aesthetic feature to the design. The sleeve has a slot 8 and the component 10 a projection 13 on its distal side, which fits in the slot 8. The proximal side of the component has a key recess formation 11 and the grip 12 has a matching key spigot or peg 14 which fits in the recess formation 11, when the grip is placed against the device, to open and close the tap.

FIGS. 15 to 22 show an embodiment of the invention in which the grip is permanently on the device but has to be depressed against a spring 25 to be able to open and close the tap.

The device includes a grip 15 and a cover 16, which together conceal the tap spindle. The view of FIG. 23 has the grip removed, to show the sleeve 17, which is fastened to the tap spindle by screws 26. The spring 25 acts against the sleeve and the grip, holding the grip in the position shown, when the grip is pushed inwards, the longitudinal wings 18 of the sleeve are engaged by the longitudinal slots 19 of the grip to enable the sleeve and hence the tap spindle to be rotated by the grip (see FIG. 22). The grip is prevented from coming off by the screw 20, which allows the grip to be pushed in. The cover merely conceals the spindle.

FIGS. 21 and 22 contrast the position of the grip showing how it may be freely rotated and not turn the tap until the grip is depressed, when the wings engage the slots, so that turning the grip turns the tap.

### REFERENCE NUMERALS

1 device
2 tap spindle
3 existing housing of tap
4 sleeve
5 sleeve screws
6 alternate sleeve
7 cover
8 slot
9 screw
10 component
11 key recess formation
12 grip
13 projection
14 key spigot or peg
15 grip
16 cover
17 sleeve
18 wings
19 slots
20 screw
25 spring
26 screws for sleeve

1. A device for controlling operation of a tap, which includes a sleeve adapted to fit over a spindle of a tap after removal of the tap handle from the spindle, the sleeve having a fastening means to fasten it to the spindle, the sleeve having a key formation presented at its distal end and further includes a co-acting key formation adapted to be fitted to a grip.

2. A device as claimed in claim 1, in which the tap handle is employed as the grip.

3. A device as claimed in claim 2, in which there is provided a means of holding or storing the handle with fitted key formation and adapted for mounting in a safe and convenient location.

4. A device as claimed in claim 1, in which the key formation of the grip is spring loaded out of engagement with the sleeve key formation of the sleeve, so that normally it will not operate the tap, but if the grip is simultaneously pushed so that the key formation of the grip engages the key formation of the sleeve, then turning the grip will operate the tap.

5. A device as claimed in claim 1, in which a cover or case is provided, adapted to conceal the sleeve, except for its distal end that presents the key formation.

6. A device as claimed in claim 1, in which the key formation presented at the distal end of the sleeve is a socket-like or female formation to which a spigot-like or male formation can be engaged to provide a rotational connection, but allow easy withdrawal of one from the other.

7. A device as claimed in claim 1, which is provided as a set or kit consisting of more than one sleeve, of varying diameters, to provide for different taps or ranges of taps.

8. A device as claimed in claim 1, which is provided with a basic sleeve and one or more supplementary sleeves, dimensioned to fit into the basic sleeve so as to allow reducing the effective inner dimension once the supplementary sleeve has been fitted into the basic sleeve, to provide the desired close fit on a smaller diameter tap spindle.

9. A device as claimed in claim 1, which is provided with a set or kit of key formations for different tap handles.

10. A device as claimed in claim 1, provided together with a tool required for applying the device, included in the kit or set, to be sold as a package.

11. A method of use of the device claimed in claim 1, which includes the steps of removing the handle of a tap from the tap spindle, fitting the sleeve over the spindle and fastening the sleeve to the spindle, fitting the co-acting key formation to the grip or tap handle and storing the tap handle in a secure place.
